(19) United States
(12) Patent Application Publication
(10) Pub. No.: US 2026/0232139 A1
(43) Pub. Date: Aug. 13, 2026

(54) ALL-IN-ONE SPARKLING JUICE MAKER

(71) Applicant: ZHONGSHAN Zhixuan Technology Co., Ltd, Zhongshan (CN)

(72) Inventor: Meiwen Liu, Zhongshan (CN)

(21) Appl. No.: 19/281,789

(22) Filed: Jul. 28, 2025

(30) Foreign Application Priority Data
Feb. 11, 2025 (CN) 202510150542.5

(51) Int. Cl. A47J 43/046; A47J 43/08; B01F 23/2361; B01F 27/808; B01F 35/32; B01F 35/71; B01F 101/00

(52) U.S. Cl. CPC A47J 43/046; A47J 43/085; B01F 23/2361; B01F 27/808; B01F 35/3204; B01F 35/71805; B01F 2101/1805

(57) ABSTRACT

An all-in-one sparkling juice maker comprises a main unit and a beverage container, the main unit is provided with an aeration device and a driving device; the beverage container is provided with a juicing assembly, a detachable connection structure and a docking structure are provided between the beverage container and the main unit, the driving device is in transmission connection with the juicing assembly after the beverage container and the main unit are connected; and a top of the beverage container is provided with a gas delivery port communicating with its inner cavity, a top of the main unit is connected to a gas delivery arm for moving, and the gas delivery arm is provided with a gas delivery channel connected to the aeration device, and an aeration structure connected the gas delivery channel with the gas delivery port. The invention has various functions.

### CROSS REFERENCE TO RELATED APPLICATIONS

The present application claims the benefit of Chinese Patent Application No. 202510150542.5 filed on Feb. 11, 2025, the contents of which are incorporated herein by reference in their entirety.

### TECHNICAL FIELD

The invention relates to an all-in-one sparkling juice maker.

### BACKGROUND ART

In the existing fields of household and commercial food processing equipment, juicer is a common type of kitchen appliance widely used to extract juice from fruits, vegetables, and other ingredients. With the improvement of living standards and the enhancement of health awareness, the market's demand for drinks is no longer limited to traditional pure juice, but tends towards more diverse product experiences. For example, sparkling drinks can provide a fresher taste and are loved by many consumers. Traditional juicers still have many problems as follows: their functions are too single, and traditional juicers and sparkling water makers are independent. If users want to enjoy fresh juicing and sparkling drinks at the same time, they must purchase two different machines, which not only increases costs but also occupies valuable kitchen space; and the operation is complex, and the separate equipment design leads to a more complicated operation process. For example, when preparing a glass of carbonated fresh juice, users first need to use a juicer to make the juice, then transfer it to another container and use a sparkling water maker for inflation treatment. This multi-step process reduces efficiency and may affect the quality of the final drink; and the difficulty of cleaning is high, and the conversion between single-function equipments often requires additional cleaning work, especially when two processes involve different types of liquids (such as pure water and fruit and vegetable juice). Ensuring that each component is thoroughly cleaned becomes particularly important. However, due to the design limitations of existing equipment, some parts are difficult to clean and can easily become places for bacterial growth; and user experience is limited, and users are restricted by existing equipment functions when pursuing personalized drinks. For example, they may want to adjust the sparkling strength or try mixing different kinds of fresh ingredients to create unique flavor combinations, but it is difficult to find products that meet these needs in the current market solutions.

The invention has been made in view of the above-mentioned disadvantages.

### SUMMARY OF THE INVENTION

The object of the invention is to overcome the shortcomings of the prior art and provide an all-in-one sparkling juice maker with various functions, strong adaptability, easy operation and cleaning, and improved comfort in use.

The invention is achieved by the following technical solutions.

The invention provides an all-in-one sparkling juice maker, comprising a main unit and at least a beverage container, the main unit is provided with an aeration device and at least a driving device; the beverage container is provided with a juicing assembly configured to rotate, chop and stir, a detachable connection structure is provided between the beverage container and the main unit for connecting the beverage container and the main unit, and a docking structure is provided between the beverage container and the main unit so that the driving device is in transmission connection with the juicing assembly after the beverage container and the main unit are connected; and a top of the beverage container is provided with at least a gas delivery port in communication with its inner cavity, a top of the main unit is connected to at least a gas delivery arm configured to move above the beverage container, and the gas delivery arm is provided with at least a gas delivery channel configured to connect with the aeration device, and an aeration structure configured to connect the gas delivery channel with the gas delivery port of the beverage container.

In the all-in-one sparkling juice maker, the gas delivery arm is provided with at least a gas delivery hose configured to connect to the aeration device, an inner cavity of the gas delivery hose constitutes the gas delivery channel, the aeration structure includes a pressing assembly, the pressing assembly is slidably connected to the gas delivery arm in an up-and-down direction for manual pressing, at least a first elastic member for pushing the pressing assembly to reset upwards is provided between the pressing assembly and the gas delivery arm, and the gas delivery hose is provided with a gas delivery section vertically arranged near a gas outlet end; and the gas delivery section is connected to the pressing assembly so that when the pressing assembly slides downwards, the gas delivery section is driven to be inserted downwards into the gas delivery port of the beverage container.

In the all-in-one sparkling juice maker, the aeration device includes a gas bottle, a top of the gas bottle is provided with a pressing valve for pressing and discharging gas, and the aeration structure further includes a linkage member configured to press the pressing valve when the pressing assembly is pressed down.

In the all-in-one sparkling juice maker, the top of the gas bottle is connected to a top cover seat, the top cover seat is provided with at least a gas outlet channel located above the pressing valve allow the gas bottle to release gas, the gas delivery hose is connected to the top cover seat and communicated with the gas outlet channel, the gas outlet channel is provided with a release valve stem configured to press the pressing valve, one end of the linkage member is rotatably connected to the gas delivery arm, another end of the linkage member is in abutment with the pressing assembly so that when the pressing assembly is pressed down, the end of the linkage member is driven to move downwards, and a middle part of the linkage member is provided with at least a contact post configured to contact with a top of the release valve stem.

In the all-in-one sparkling juice maker, the detachable connection structure includes at least a mounting groove provided on the main unit for receiving an insertion of the beverage container from top to bottom, and the detachable connection structure includes at least an L-shaped groove provided on a wall of the mounting groove, a side wall of the beverage container is provided with at least an engagement boss configured to be engaged into a vertical section of the L-shaped groove from top to bottom and be engaged into a transverse section of the L-shaped groove when the beverage container rotates.

In the all-in-one sparkling juice maker, the driving device adopts at least a motor, the docking structure includes at least a first engagement member connected to an output shaft of the motor, and at least a second engagement member connected to the juicing assembly, and when the beverage container is connected to the main unit, the first engagement member interlocks with the second engagement member for transmission.

In the all-in-one sparkling juice maker, the gas delivery arm is rotatably connected to the main unit.

In the all-in-one sparkling juice maker, a locking structure configured to lock the gas delivery arm after the gas delivery arm rotates by a pre-set angle is provided between the gas delivery arm and the main unit.

In the all-in-one sparkling juice maker, the sparkling beverage container includes a bottle body and a bottle cap assembly connected to the bottle body, the bottle cap assembly is provided with at least a first gas intake channel communicating with an outside and at least a second gas intake channel communicating with an inside of the bottle body, and a one-way valve is provided between the first gas intake channel and the second gas intake channel to allow the gas to enter the latter from the former.

In the all-in-one sparkling juice maker, the bottle cap assembly is further provided with a pressure relief structure configured to release the gas in the bottle body to the outside.

Compared with the prior art, the invention has the following advantages.
1. Diversification of functions: the invention combines the functions of juicing and preparing carbonated beverage, enabling two different types of beverage preparation in a compact design, meeting user's needs for fresh fruit and vegetable juices and drinks with a sparkling taste. This not only saves kitchen space, but also reduces the cost of purchasing a variety of equipment.
2. Operation convenience: the detachable connection structure and the docking structure in the invention simplify an installation process between the sparkling beverage container and the main unit, allowing users to easily remove the sparkling beverage container from the main unit for cleaning or replacement, and ensuring a stable mechanical connection and power transmission between the two; and the design of the gas delivery arm allows it to be rotated into an appropriate position to facilitate the installation or removal of the sparkling beverage container, while the locking structure ensures the stability of the gas delivery arm at a correct working angle, thereby enhancing the convenience and safety of use.
3. User experience enhancement: the design of the pressing assembly allows users to intuitively and easily control the aeration process, and the gas injection can be achieved by a simple pressing action.
4. Simple and clear operation: the one-way valve and pressure relief structure of the bottle cap assembly provide a double safety protection mechanism to prevent the safety hazards caused by excessive internal pressure, and also ensure the stability of a product in a using process, thereby improving user's trust and satisfaction.
5. Hygiene and cleaning guarantee: removable sparkling beverage container facilitate thorough cleaning, help to keep the interior of the machine clean, avoid the growth of bacteria, and ensure the hygienic quality of beverage. In addition, a blade structure of the juicing assembly is easy to clean, reducing the possibility of sticking of residual material.
6. Energy-saving and environment-friendly: using industry-standard small-capacity carbon dioxide gas bottle as an aeration source not only meets the environmental requirements, but also lowers a user's threshold because of the easy availability and low cost. Moreover, the pressing valve design at the top of the gas bottle releases gas only when needed, effectively saving resources and reducing waste.
7. Extended service life: the pressure relief structure not only improves the safety of the product, but also reduces the wear of internal components due to high pressure to a certain extent, which helps to prolong the service life of the whole equipment.
8. Strong adaptability: this all-in-one machine is suitable for various scenarios such as home, office, even outdoor, which provides great flexibility for consumers. It can be used not only to produce fresh fruit juice for daily consumption, but also to adjust the carbonation levels according to personal preferences, which is suitable for different taste preferences.

### BRIEF DESCRIPTION OF THE DRAWINGS

FIG. 1 is a schematic view illustrating a structure of an all-in-one sparkling juice maker of the invention;

FIG. 2 is a sectional view of an all-in-one sparkling juice maker of the invention;

FIG. 3 is an enlarged view of part A of FIG. 2;

FIG. 4 is an exploded view of the all-in-one sparkling juice maker of the invention;

FIG. 5 is a sectional view of the gas delivery arm of the invention;

FIG. 6 is an exploded view of a sparkling beverage container of the invention; and

FIG. 7 is a partial sectional view of the sparkling beverage container of the invention.

### DETAILED DESCRIPTION OF THE INVENTION

The invention will be described in further detail below with reference to the drawings.

The orientations described herein, such as “upper”, “lower”, “left”, “right”, “front”, “back”, and the like, are with reference to the orientation of the figures for purposes of describing the relationship of the various elements and are not intended to indicate a unique or absolute positional relationship between the various elements, but are merely one implementation mode of the invention and are not a limitation of its implementation modes.

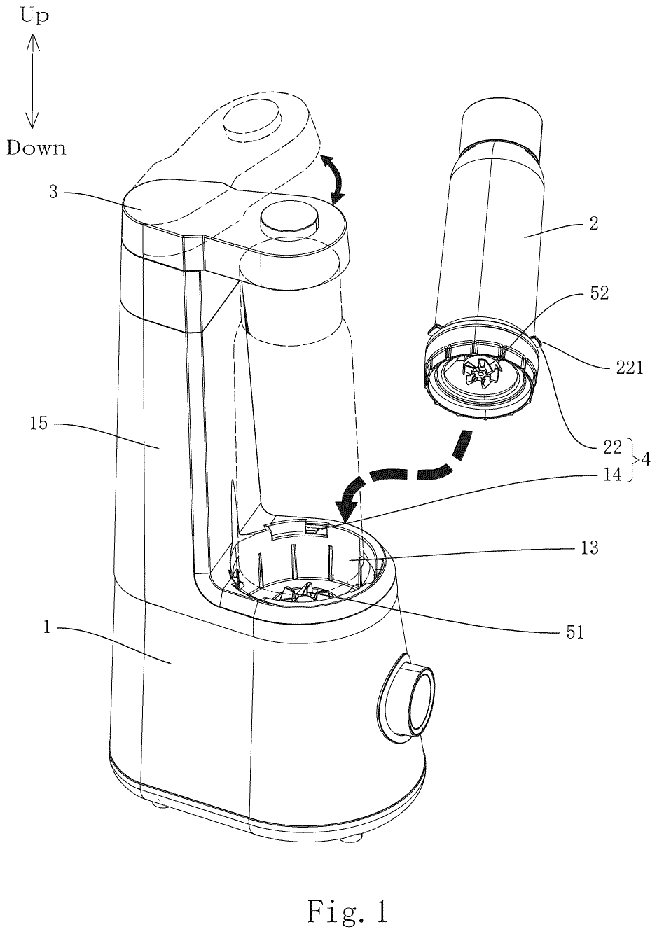

As shown in FIGS. 1 to 3, the invention provides an all-in-one sparkling juice maker, comprising a main unit 1 and a beverage container 2, the main unit 1 is provided with an aeration device 11 and at least a driving device 12. The aeration device 11 is generally at least a gas bottle, and the driving device 12 generally adopts at least a motor and output transmission members.

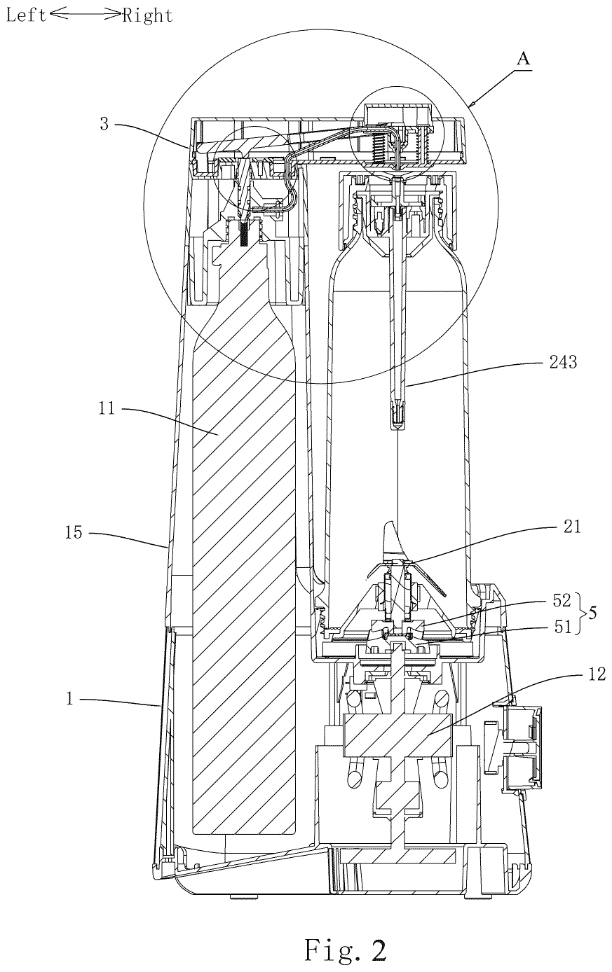

As shown in FIG. 2, the beverage container 2 is provided with a juicing assembly 21 configured to rotate, cut and stir vegetables and fruits, a detachable connection structure 4 is provided between the beverage container 2 and the main unit 1 so that the beverage container 2 can be connected to the main unit 1, and a docking structure 5 is provided between the beverage container 2 and the main unit 1 so that the driving device 12 is in a transmission connection with the juicing assembly 21 after the beverage container 2 and the main unit 1 are connected. The juicing assembly 21 adopts a radially extending, circumferentially distributed blade structure, and through the docking structure 5, the driving device 12 can drive the juicing assembly 21 to rotate so as to achieve functions of crushing, cutting, mixing and the like. Subsequently, juice can be extracted from fruits, vegetables and other foods in the beverage container 2.

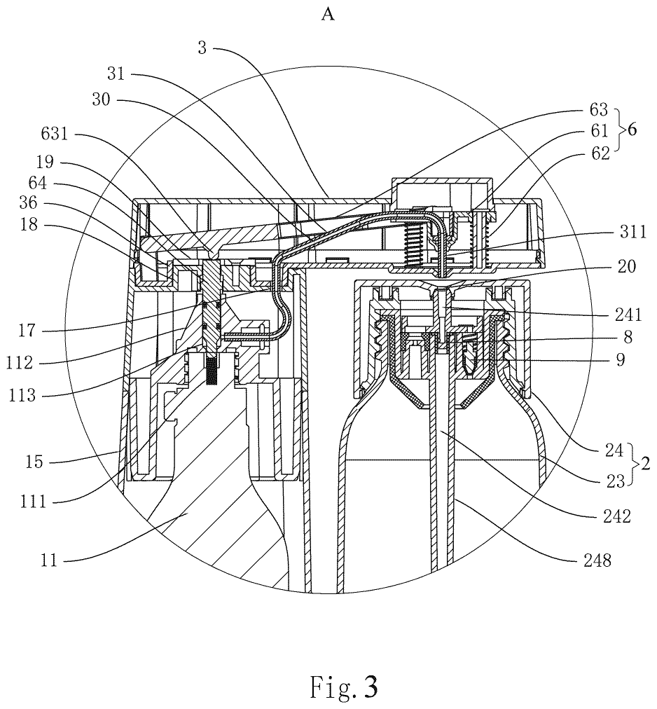

As shown in FIGS. 2 and 3, a top of the beverage container 2 is provided with at least a gas delivery port 20 in communication with its inner cavity, and a top of the main unit 1 is connected to at least a gas delivery arm 3 configured to move above the beverage container 2. The gas delivery arm 3 is provided with a gas delivery channel 30 for connecting to the aeration device 11, and an aeration structure 6 for connecting the gas delivery channel 30 with the gas delivery port 20 of the beverage container 2, so that juice in the beverage container 2 can be injected with gas to produce a sparkling beverage.

The all-in-one product of the above-mentioned solution can simultaneously achieve functions of juicing and preparing bubbles in a compact product, making the functions of product more diversified and having a wider range of usage scenarios.

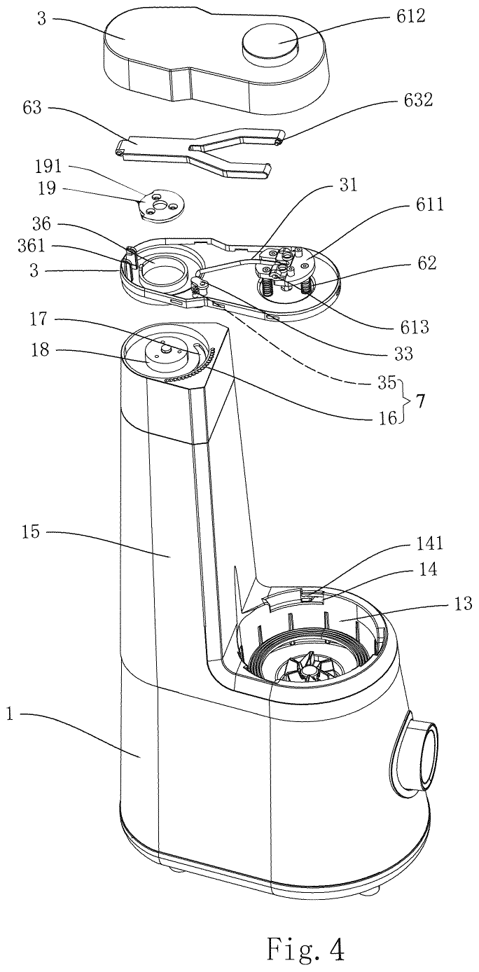

As a preferred embodiment of the aeration structure 6, as shown in FIGS. 3 and 4, the gas delivery arm 3 is provided with at least a gas delivery hose 31 configured to connect to the aeration device 11, an inner cavity of the gas delivery hose 31 constitutes the gas delivery channel 30, the aeration structure 6 includes a pressing assembly 61, the pressing assembly 61 is composed of at least a pressing seat 611 and at least a button 612, the pressing assembly 61 is slidably connected to the gas delivery arm 3 in an up-and-down direction for manual pressing, and at least a first elastic member 62 for pushing the pressing assembly 61 to reset upwards is provided between the pressing assembly 61 and the gas delivery arm 3. The gas delivery hose 31 is provided with a gas delivery section 311 vertically arranged near a gas outlet end, and the gas delivery section 311 is connected to the pressing assembly 61 so that when the pressing assembly 61 slides downwards, the gas delivery section 311 is driven to be inserted downwards into the gas delivery port of the beverage container 2, thereby completing the aeration action.

As a further preferable embodiment, the aeration device 11 includes a gas bottle, a top of the gas bottle is provided with at least a pressing valve 111 for pressing and discharging gas, and the aeration structure 6 further includes a linkage member 63 configured to press the pressing valve 111 when the pressing assembly 61 is pressed down.

In detail, the gas bottle is an industry standard carbon dioxide gas bottle with a small capacity for a sparkling water machine, that is to say, after the pressing valve 111 at the top of the gas bottle is pressed, the gas bottle can normally release gas. For the specific structure, reference can be made to the patent of patent number CN202221412403.3, entitled “carbon dioxide aluminum bottle valve”. The top of the gas bottle is connected to a top cover seat 112, the top cover seat 112 is provided with at least a gas outlet channel 113 located above the pressing valve 111 allow the gas bottle to release gas, the gas delivery hose 31 is connected to the top cover seat 112 and is in communication with the gas outlet channel 113, the gas outlet channel 113 is provided with a release valve stem 64 configured to press the pressing valve 111, one end of the linkage member 63 is rotatably connected to the gas delivery arm 3, another end of the linkage member 63 abuts against the pressing assembly 61 so that when the pressing assembly 61 is pressed down, the end of the linkage member 63 is driven to move downwards, and a middle part of the linkage member 63 is provided with at least a contact post 631 in contact with a top of the release valve stem 64. Preferably, the linkage member 63 is a Y-shaped rod, including two sub-rods at its right end. The two sub-rods are provided with a latching post 632 respectively, and the pressing seat 611 is provided with insertion holes 613 for inserting the latching posts 632, so that when the pressing assembly 61 is pressed downwards, the linkage member 63 is driven to swing. When the linkage member 63 swings, the release valve stem 64 is pressed downwards by the contact post 631, and the release valve stem 64 is pressed downwards to push the pressing valve 111 so as to allow the gas bottle to release gas, and released carbon dioxide gas is transmitted into the beverage container 2 via the gas delivery hose 31. In order not to affect the swinging of the linkage member 63 when the pressing seat 611 moves up and down, a sufficient gap is left between the insertion hole 613 and the latching post 632 correspondingly or each insertion hole 613 is provided as a transversely elongated hole. The Y-shaped linkage member 63 can better avoid the pressing assembly 61, and further ensure a more balanced force when the pressing assembly 61 is pressed down, thereby further ensure the stability of the overall structural downward pressure.

As a preferred embodiment of the detachable connection structure 4, as shown in FIGS. 1 and 4, the detachable connection structure 4 includes at least a mounting groove 13 provided on the main unit 1 for receiving an insertion of the beverage container 2 from top to bottom. The detachable connection structure 4 includes at least an L-shaped groove 14 provided on a wall of the mounting groove 13, and a side wall of the beverage container 2 is provided with at least an engagement boss 22 configured to be engaged into a vertical section of the L-shaped groove 14 from top to bottom and be engaged into a transverse section of the L-shaped groove 14 when the beverage container 2 rotates. Therefore, it is only necessary to insert the beverage container 2 into the mounting groove 13 from the top to the bottom and rotate the beverage container 2 to complete the mounting. As a further optimization, the engagement boss 22 is provided with at least a locking protrusion 221, and the transverse section of the L-shaped groove 14 is provided with at least a locking groove 141 for engaging with the locking protrusion 221.

As a preferred embodiment of the docking structure 5, as shown in FIGS. 1 and 2, the docking structure 5 includes at least a first engagement member 51 connected to an output shaft of the motor and at least a second engagement member 52 connected to the juicing assembly. When the beverage container 2 is connected to the main unit 1, the first engagement member 51 is engaged with the second engagement member 52 for transmission; and in order to realize transmission by engaging, docking surfaces of the first engagement member 51 and the second engagement member 52 are provided with at least a clamping protrusion and at least a clamping recess for clamping.

As a preferred embodiment, as shown in FIG. 1, the gas delivery arm 3 is rotatably connected to the main unit 1, wherein a right part of the main unit 1 is provided with a mounting groove 13 for mounting a beverage container 2 from top to bottom, and a left part of the main unit 1 is provided with at least a mounting post 15. In the embodiment, a top of the mounting post 15 is rotatably connected to the gas delivery arm 3, and a left part of the gas delivery arm 3 is rotatably connected to the main unit 1, so that when the gas delivery arm 3 rotates, its right part can be positioned above or away from the mounting groove 13. When the gas delivery arm 3 is rotated to its right part is misaligned with the mounting groove 13, that is, when it is at a front side or a rear side of the mounting groove 13, the beverage container 2 can be easily mounted in the mounting groove 13 from the top to the bottom. Then, the gas delivery arm 3 is rotated again so that the right part thereof is positioned above the mounting groove 13, and aeration is performed by aligning the aeration structure 6 with the gas delivery port 20 of the beverage container 2. The above-mentioned design simplifies processes of mounting and dismounting the beverage container 2.

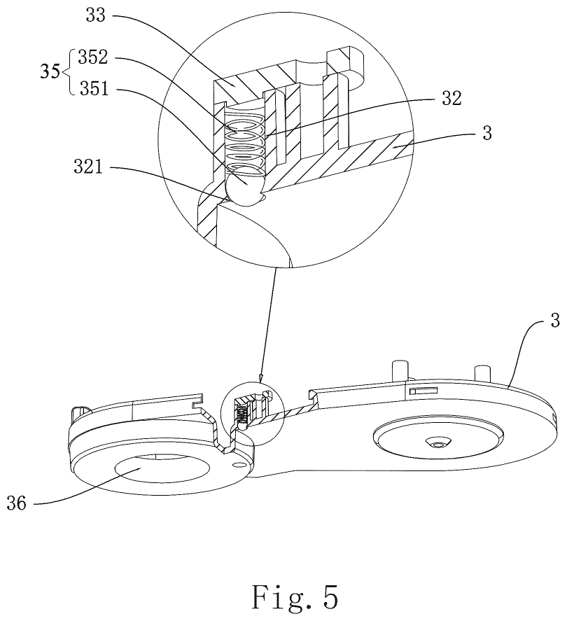

As a further optimization, as shown in FIGS. 4 and 5, a locking structure 7 configured to lock the gas delivery arm 3 when the gas delivery arm 3 rotates by a preset angle is provided between the gas delivery arm 3 and the main unit 1, and the locking structure 7 is capable of locking the gas delivery arm 3 when the gas delivery arm 3 rotates by a preset angle. More specifically, the locking structure 7 includes a plurality of positioning grooves 16 provided at the top of the mounting post 15, and a positioning assembly 35 configured to be snapped into one of the positioning grooves 16 after the gas delivery arm 3 is rotated by a preset angle. The gas delivery arm 3 is provided with a mounting hole 32, and its top end is closed by a sealing cover 33. The positioning assembly 35 includes a top ball 351 and a spring 352 installed in the mounting hole 32. A bottom end of the mounting hole 32 is provided with an exposing hole 321 having a smaller diameter than the top ball 351. One end of the spring 352 abuts against an upper side of the top ball 351, and another end of the spring 352 abuts against the sealing cove 33. In addition, the positioning grooves 16 are spherical arc-shaped grooves distributed circumferentially around a rotation center of the gas delivery arm 3. By pre-setting a spacing between the positioning grooves 16, preset angles of rotation of the gas delivery arm 3 can be set. When the gas delivery arm 3 is rotated by a preset angle, the top ball 351 is pressed into one positioning groove 16, thereby locking the gas delivery arm 3. The locking force depends on the spring force of the spring 352, and user can twist the gas delivery arm 3 with a relatively large moment, so that the top ball 351 escapes from the positioning groove 16, thereby achieving a twisting operation with different damping, providing the user with a resistance feedback on the angle rotated of the gas delivery arm 3, and facilitating the user's operation and improving the use experience at the same time.

In order to make the structure of the product more compact, in the embodiment, the gas delivery hose 31 is preferably made of soft materials such as silicone rubber, and the gas bottle is provided on an inner side of the mounting post 15. The top of the mounting post 15 is provided with at least an avoidance hole 17 through which the gas delivery hose 31 passes, so that the gas delivery hose 31 can pass through this hole to be connected to the gas bottle. The avoidance hole 17 is designed as an arc-shaped hole whose center coincides with center of rotation of the gas delivery arm 3, so as to ensure that the gas delivery hose 31 is not obstructed or interfered with by other structures when the gas delivery arm 3 rotates.

Further, as shown in FIGS. 3 and 5, the top of the mounting post 15 is provided with a connecting boss 18, and the gas delivery arm 3 is provided with a connecting sleeve 36 configured to sleeve on the connecting boss 18. A top of the connecting boss 18 is provided with at least a mounting plate 19 configured to prevent the connecting sleeve 36 from escaping outwards, achieving a rotary connection between the gas delivery arm 3 and the mounting post 15. As a further optimization design, the mounting plate 19 is provided with at least a limiting notch 191 circumferentially arranged, and the connecting sleeve 36 is provided with at least a limiting portion 361 extending into the limiting notch 191. Such a design ensures that the gas delivery arm 3 can only rotate within a pre-set angle range, increasing the safety and controllability of operation.

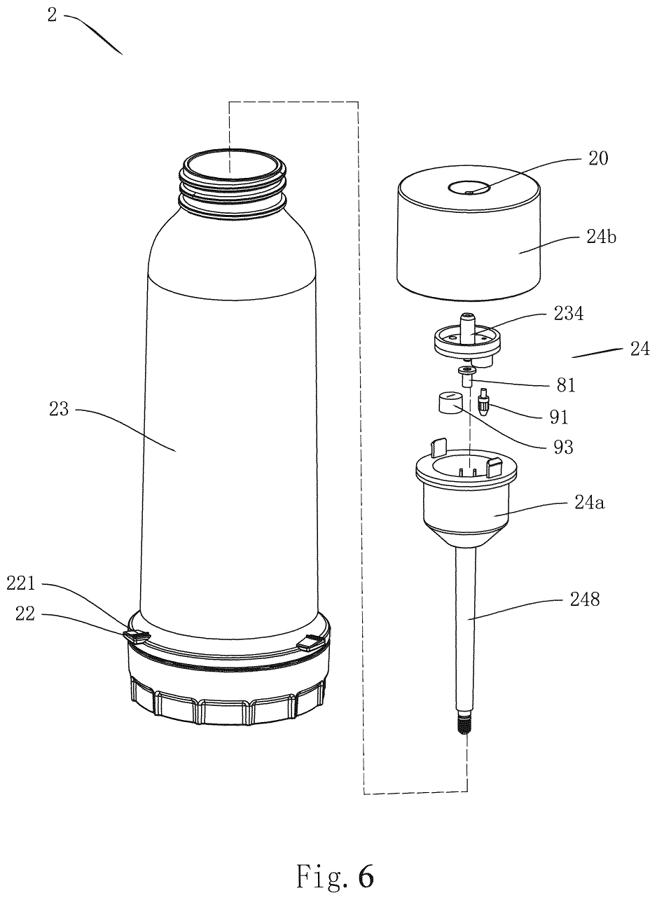

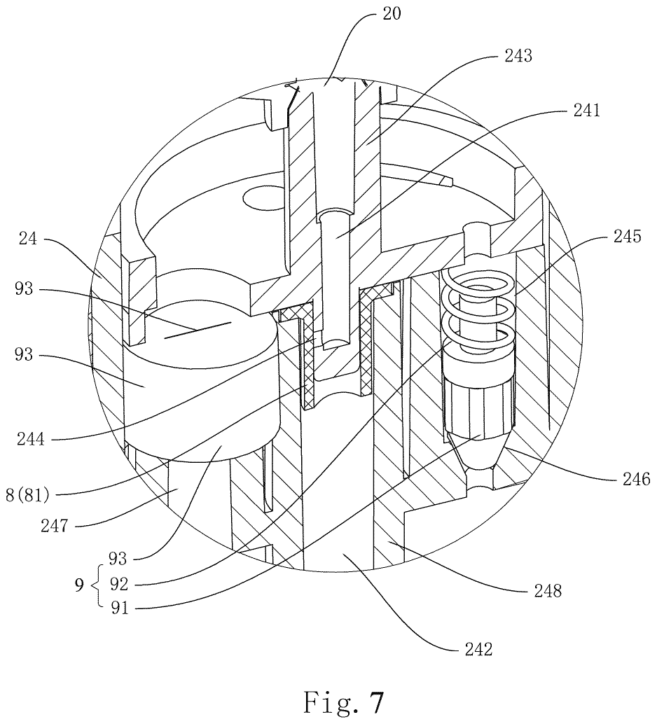

As a preferred embodiment, as shown in FIGS. 6 and 7, the beverage container 2 includes a bottle body 23 and a bottle cap assembly 24 connected to the bottle body 23. As shown in FIG. 7, the bottle cap assembly 24 includes a top cap 24b and an inner seat 24a, the inner seat 24a is provided with at least an aeration tube 248 for inserting into juice, the bottle cap assembly 24 is provided with at least a first gas intake channel 241 communicating with an outside and at least a second gas intake channel 242 communicating with an inside of the bottle body, and an inner cavity of the aeration tube 248 constitutes the second gas intake channel 242. A one-way valve 8 is provided between the first gas intake channel 241 and the second gas intake channel 242 to allow gas to enter the latter from the former. As shown in FIG. 7, the bottle cap assembly 24 includes a delivery tube 243, an inner cavity of the delivery tube 243 constitutes the first gas intake channel 241, a bottom of the delivery tube 243 is closed, and a side wall of the bottom of the delivery tube 243 is provided with at least a through hole 244. The one-way valve 8 is an expansion sleeve 81 which is sheathed outside the bottom of the delivery tube 243 and closes the through hole 244, a bottom of the expansion sleeve 81 is open, and when gas enters the first gas intake channel 241, the expansion sleeve 81 can be expanded so as to enable gas flow to be delivered from an inner wall of the expansion sleeve 81 into the second gas intake channel 242.

In a preferred embodiment, as shown in FIGS. 6 and 7, the bottle cap assembly 24 is further provided with a pressure relief structure 9 configured to release the gas in the bottle to the outside. As shown in FIG. 7, the bottle cap assembly 24 is provided with at least a first pressure relief channel 245 for communicating with the outside, and a lower end of the first pressure relief channel 245 is provided with an inverted frustum inclined surface 246. The pressure relief structure 9 includes a valve block 91 which is provided in the first pressure relief channel 245 and can move up and down, a lower end of the valve block 91 is in an inverted frustum shape which can fit with the inverted frustum inclined surface 246, and an upper end of the valve block 91 is provided with at least an elastic member 92 configured to push the valve block 91 to move downwards to block the first pressure relief channel 245. The bottle cap assembly 24 is provided with a second pressure relief channel 247, the pressure relief structure 9 further includes an elastic pressure relief plug 93 fixed in the second pressure relief channel 247, and a flat pressure relief hole 931 is cut in a middle of the elastic pressure relief plug 93. In the embodiment, the valve block 91 with the elastic member 92 is provided in the first pressure relief channel 245, and this structure has a high sensitivity to a gas pressure in the bottle. When the gas pressure in the bottle increases, it can quickly respond to and release excess pressure, and automatically close after the gas pressure returns to normal. In the second pressure relief channel 247, there is the elastic pressure relief plug 93 with the flat pressure relief hole 931 cut, and when the gas pressure in the bottle is too high and a pressure relief flow of the first pressure relief channel 245 is saturated, an additional pressure relief safety guarantee is provided. This double protection mechanism improves the safety of use, and can timely control the gas pressure in the bottle within a certain threshold value, and prolongs the service life of the equipment.

As one of the further embodiments: the first pressure relief channel 245 is provided with an elastic member 92 and a valve block 91, while the second pressure relief channel 247 has the same structure. As another further embodiment: the second pressure relief channel 247 is provided with an elastic pressure relief plug 93 containing a pressure relief hole 931, while the first pressure relief channel 245 adopts an identical structure.

The above contents are only embodiments of the invention, and the specific structures and characteristics commonly known in the invention are not described in detail herein. It should be noted that various changes and modifications could be made by those skilled in the art without departing from the structure of the invention. These should also be considered as the scope of protection of the invention, and they will not affect the effectiveness of the implementation of the invention and the practicality of the patent. The scope of protection of the application should be determined by the contents of the claims, and the specific implementation methods and other records in the description can be used to interpret the content of the claims.

What is claimed is

1. An all-in-one sparkling juice maker, comprising a main unit and at least a beverage container, the main unit is provided with an aeration device and at least a driving device; the beverage container is provided with a juicing assembly configured to rotate, chop and stir, a detachable connection structure is provided between the beverage container and the main unit for connecting the beverage container and the main unit, and a docking structure is provided between the beverage container and the main unit so that the driving device is in transmission connection with the juicing assembly after the beverage container and the main unit are connected; and a top of the beverage container is provided with at least a gas delivery port in communication with its inner cavity, a top of the main unit is connected to at least a gas delivery arm configured to move above the beverage container, and the gas delivery arm is provided with at least a gas delivery channel configured to connect to the aeration device, and an aeration structure configured to connect the gas delivery channel with the gas delivery port of the beverage container.

2. The all-in-one sparkling juice maker according to claim 1, wherein the gas delivery arm is provided with at least a gas delivery hose configured to connect to the aeration device, an inner cavity of the gas delivery hose constitutes the gas delivery channel, the aeration structure includes a pressing assembly, the pressing assembly is slidably connected to the gas delivery arm in an up-and-down direction for manual pressing, at least a first elastic member for pushing the pressing assembly to reset upwards is provided between the pressing assembly and the gas delivery arm, and the gas delivery hose is provided with a gas delivery section vertically arranged near a gas outlet end; and the gas delivery section is connected to the pressing assembly so that when the pressing assembly slides downwards, the gas delivery section is driven to be inserted downwards into the gas delivery port of the beverage container.

3. The all-in-one sparkling juice maker according to claim 2, wherein the aeration device includes a gas bottle, a top of the gas bottle is provided with at least a pressing valve for pressing and discharging gas, and the aeration structure further includes a linkage member configured to press the pressing valve when the pressing assembly is pressed down.

4. The all-in-one sparkling juice maker according to claim 3, wherein the top of the gas bottle is connected to a top cover seat, the top cover seat is provided with at least a gas outlet channel located above the pressing valve allow the gas bottle to release gas, the gas delivery hose is connected to the top cover seat and communicated with the gas outlet channel, the gas outlet channel is provided with a release valve stem configured to press the pressing valve, one end of the linkage member is rotatably connected to the gas delivery arm, another end of the linkage member is in abutment with the pressing assembly so that when the pressing assembly is pressed down, the end of the linkage member is driven to move downwards, and a middle part of the linkage member is provided with at least a contact post configured to contact with a top of the release valve stem.

5. The all-in-one sparkling juice maker according to claims 1, wherein the detachable connection structure includes at least a mounting groove provided on the main unit for receiving an insertion of the beverage container from top to bottom, and the detachable connection structure includes at least an L-shaped groove provided on a wall of the mounting groove, a side wall of the beverage container is provided with at least an engagement boss configured to be engaged into a vertical section of the L-shaped groove from top to bottom and be engaged into a transverse section of the L-shaped groove when the beverage container rotates.

6. The all-in-one sparkling juice maker according to claim 5, wherein the driving device adopts at least a motor, the docking structure includes at least a first engagement member connected to an output shaft of the motor, and at least a second engagement member connected to the juicing assembly, and when the beverage container is connected to the main unit, the first engagement member interlocks with the second engagement member for transmission.

7. The all-in-one sparkling juice maker according to claim 1, wherein the gas delivery arm is rotatably connected to the main unit.

8. The all-in-one sparkling juice maker according to claim 7, wherein a locking structure configured to lock the gas delivery arm after the gas delivery arm rotates by a pre-set angle is provided between the gas delivery arm and the main unit.

9. The all-in-one sparkling juice maker according to claim 1, wherein the beverage container includes a bottle body and a bottle cap assembly connected to the bottle body, the bottle cap assembly is provided with at least a first gas intake channel communicating with an outside and at least a second gas intake channel communicating with an inside of the bottle body, and a one-way valve is provided between the first gas intake channel and the second gas intake channel to allow gas to enter the latter from the former.

10. The all-in-one sparkling juice maker according to claim 9, wherein the bottle cap assembly is further provided with a pressure relief structure configured to release the gas in the bottle body to the outside.
